(19) United States
(12) Patent Application Publication
(10) Pub. No.: US 2025/0120862 A1
(43) Pub. Date: Apr. 17, 2025

(54) DYNAMIC CUSHIONING DEVICE FOR PRESSURE INJURY PREVENTION AND TREATMENT

(71) Applicant: Jamasb Sayadi, Aliso Viejo, CA (US)

(72) Inventor: Jamasb Sayadi, Aliso Viejo, CA (US)

(21) Appl. No.: 18/912,104

(22) Filed: Oct. 10, 2024

Related U.S. Application Data
(60) Provisional application No. 63/589,524, filed on Oct. 11, 2023.

(51) Int. Cl. A61G 7/057; A47C 27/08

(52) U.S. Cl. CPC A61G 7/05769; A47C 27/082; A47C 27/083

(57) ABSTRACT

A device for reducing pressure against a region of a body of a user is described herein. The device includes a plurality of inflatable cushion surfaces for supporting the body region of the user. The device includes an expansion console having a power source and an inflation unit. The device further includes a plurality of channels connecting the cushion surfaces to the inflation unit. The device has a controller configured to cause the expansion console to inflate and/or deflate any one of the cushion surfaces so as to vary degrees of inflation of the cushion surfaces over time to create a cyclical pattern of pressure redistribution.

### CROSS-REFERENCE TO RELATED APPLICATION

The present application claims the benefit of U.S. Provisional Patent Application No. 63/589,524, filed on Oct. 11, 2023, which is hereby incorporated by reference in its entirety.

### FIELD

The disclosed embodiments relate to medical devices and systems for managing and redistributing pressure on a patient's body. More specifically, the embodiments pertain to dynamic cushioning devices that utilize controllable inflation and deflation mechanisms to prevent and treat pressure-related injuries.

### BACKGROUND

Pressure-related injuries, such as bedsores and pressure ulcers, are a significant concern in healthcare settings, particularly for patients with limited mobility or those undergoing prolonged medical procedures. Traditional pressure management solutions, including static foam mattresses and air-filled cushions, often provide insufficient prevention and can be challenging to adapt to individual patient needs. Moreover, these conventional approaches typically lack integration with treatment delivery systems, necessitating separate interventions for pressure management and wound care.

### SUMMARY

As healthcare providers seek more efficient and effective ways to prevent and treat pressure injuries, there is a growing need for dynamic, adaptable systems that can both redistribute pressure and deliver therapeutic treatments in a coordinated manner. A device for reducing pressure against a region of a body of a user re described herein. The device includes a plurality of inflatable cushion surfaces for supporting the body region of the user. The device includes an expansion console having a power source and an inflation unit. The device further includes a plurality of channels connecting the cushion surfaces to the inflation unit. The device has a controller configured to cause the expansion console to inflate and/or deflate any one of the cushion surfaces so as to vary degrees of inflation of the cushion surfaces over time to create a cyclical pattern of pressure redistribution.

A method for reducing pressure against a region of a body of a user includes positioning a plurality of inflatable cushion surfaces against the region of the body of the user. The method further includes inflating or deflating each individual cushion surface to vary a degree of inflation of each individual cushion surface over time and create a cyclical pattern of pressure redistribution such that pressure exerted on any specific point of the region of the body of the body of the user is periodically relieved.

### BRIEF DESCRIPTION OF THE DRAWINGS

FIG. 1 illustrates a device for reducing pressure against a region of a body of a user, in accordance with some embodiments.

FIG. 2 illustrates a device for reducing pressure against a region of a user's body, in accordance with some embodiments.

FIG. 3 illustrates a device for reducing pressure against a region of a user's body, in accordance with some embodiments.

FIG. 4 illustrates a pressure-reducing device mounted on a seating surface, in accordance with some embodiments.

FIG. 5 illustrates a pressure-reducing device mounted on a bed surface, in accordance with some embodiments.

FIG. 6 illustrates a pressure-reducing device having two inflatable cushion surfaces, in accordance with some embodiments.

FIG. 7 illustrates a pressure-reducing device having two inflatable cushion surfaces, in accordance with some embodiments.

FIG. 8 illustrates a device for reducing pressure against a region of a user's body, in accordance with some embodiments.

FIG. 9 illustrates a block diagram illustrating components of an example computing machine, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Pressure sores (also known as decubitus ulcers and bed sores) are wounds caused by prolonged pressure against the body. The present disclosure relates to the medical, biomedical, bioinformatics, pharmaceutical, and other scientific fields known to a person of ordinary skill in the art associated with the prevention, cure, treatment, and management of pressure sores. The most vulnerable regions are the soft tissue near the bony prominences of the body that come into firm contact with underlying surfaces (e.g., beds and wheelchairs), such as the sacrum and ischia of the pelvis. However, these ulcers can occur anywhere in the body experiencing prolonged pressures, such as the back of the head or bottom of one's heels. Pressure sores afflict more than 2.5 million individuals in the United States each year with an associated financial toll of $11.6 billion dollars on our healthcare system. Of course, pressure sores injuries are not limited to the United States, and worldwide they impact many more individuals, adding significant burden and costs on the healthcare system globally.

Pressure sores are wounds caused by prolonged pressure against the body. The most vulnerable regions may be the soft tissue near the bony prominences of the body that come into firm contact with underlying surfaces (e.g., beds and wheelchairs), such as the sacrum and ischia of the pelvis. However, these ulcers can occur anywhere in the body experiencing prolonged pressures, such as the back of the head or bottom of one's heels. Pressure sores can develop rapidly in as little as two hours when pressures against the body surface are exceedingly high (e.g., >70 mmHg). They may also form insidiously over longer periods of time so long as pressures against the body are high enough to close off capillaries that supply vital nutrients and oxygen to the skin and underlying tissues, which by some estimates is approximately 32 mmHg. The pressure may be dependent on gravity and may be different in space and other planets.

Once an ulcer has started to develop, it may progress quickly from a superficial sore down to muscle or bone. Without proper care, the sore can then become infected, lead to septic shock, and ultimately kill patients. Some stages of pressure ulcer development are described in the following sentences. At Stage 1, the sores are not open wounds. The skin may be painful, but it has no breaks or tears. The sore can feel either firmer or softer than the area around it. At Stage 2, the skin breaks open, wears away, or forms an ulcer, which is usually tender and painful. The sore expands into deeper layers of the skin. It can look like a scrape (abrasion), blister, or a shallow crater in the skin. Sometimes this stage looks like a blister filled with clear fluid. At this stage, some skin may be damaged beyond repair or may die. At Stage 3, the sore gets worse and extends into the tissue beneath the skin, forming a small crater. Fat may show in the sore, but not muscle, tendon, or bone. At Stage 4, the pressure sore is very deep, reaching into muscle and bone and causing extensive damage. Damage to deeper tissues, tendons, and joints may occur.

The risk factors for developing pressure ulcers are well-understood, including increased age, excessive moisture, friction forces, loss of sensation, weakness, underlying disease, and malnutrition. These factors may contribute to ulcer formation by reducing skin integrity, impairing weight shifting, and diminishing the body's ability to heal wounds and fight infections. Consequently, bedridden elderly and spinal cord injury patients may be at highest risk, with pressure ulcers commonly occurring in acute hospitalizations, long-term care facilities, and prolonged home care settings. With over 2.5 million new bed ulcers annually, new innovations are desperately needed to address this preventable complication.

Current prevention strategies include physical turning by caregivers every two hours, static mats and pads for pressure redistribution, and alternating pressure mattresses. However, these methods have significant limitations: they are labor-intensive, may redirect pressure to other body regions, or fail to completely offload pressure from bony prominences. The gold standard for prevention, air-fluidized beds, effectively reduces pressure but may be cost-prohibitive at up to $50,000 per bed and are not portable. This high cost limits availability, particularly in under-resourced settings, potentially preventing patients from receiving timely care for deep pressure ulcers or post-reconstructive surgery. A more cost-effective solution that can protect deep ulcers and reconstructive flaps is needed to provide an affordable, portable, and readily available tool for managing vulnerable patients.

In some embodiments, a device for reducing pressure against a region of a body of a user is provided in the present disclosure. The device includes a plurality of inflatable cushion surfaces for supporting the body region of the user. The device includes an expansion console having a power source and an inflation unit. The device further includes a plurality of channels connecting the cushion surfaces to the inflation unit. The device has a controller configured to cause the expansion console to inflate and/or deflate any one of the cushion surfaces so as to vary degrees of inflation of the cushion surfaces over time to create a cyclical pattern of pressure redistribution.

The cushion surfaces may support the body region of the user. In some embodiments, the cushion surfaces may support the body region of the user through a dynamic and adaptable approach. The cushion surfaces may conform to the user's body contours, distributing pressure evenly across the contact area to minimize stress on any particular point. The individual inflation and deflation of each cushion surface may allow for precise adjustment, creating a customized support structure that is tailored to the user's specific needs. This adaptability may provide the device to accommodate various body types and medical conditions, such as existing pressure ulcers or surgical sites. In some embodiments, the cushion surfaces are programmed to alternate their inflation levels in a coordinated manner, creating a gentle, wave-like motion that periodically shifts the pressure points on the user's body. This dynamic support may help maintain proper blood circulation, reduce the risk of pressure ulcer formation, and can aid in the healing of existing wounds.

In some embodiments, the cushion surfaces are arranged to form a shape with an open center area configured to elevate the region of the body of the user off an underlying surface. These features provide various geometric shapes (or formations), such as circular, oval, or custom-shaped arrangements, with the cushion surfaces positioned around the periphery. The open center area is adjusted in size and shape to accommodate different body parts or wound locations. By elevating the affected area, this configuration may reduce (or eliminate) direct pressure on vulnerable tissues, promoting better blood circulation and oxygenation. This arrangement is particularly beneficial for managing existing pressure ulcers, post-surgical sites, or other sensitive areas that require complete offloading. The cushion surfaces can be individually inflated or deflated to fine-tune the elevation height and pressure distribution, ensuring optimal support while maintaining the integrity of the open center. Various machine learning algorithms (e.g., probabilistic learning and neural networks) can be utilized to find optimal support (e.g., pressure distribution, body and device temperature, elevation height) for the device. This adaptable design may also facilitate wound inspection and treatment without necessitating patient repositioning, thereby reducing disturbance to the healing process. Additionally, the open center may allow for air circulation, reducing moisture buildup and further contributing to skin health. The flexibility of this arrangement may permit healthcare providers to modify the configuration as the patient's condition evolves, making it a versatile solution for various stages of pressure injury prevention and treatment.

In one embodiment, a sensing device (such as a camera) is mounted adjacent to the open center area of the cushion surface arrangement. For example, the sensing device is mounted on an adjustable arm attached to the frame or casing that holds the cushion surfaces. The arm can be positioned at the head or foot end of the open center area, extending slightly over the void space. The arm is designed to be flexible or articulated, allowing for adjustment of the sensing device's angle and distance from the wound site. This positioning can provide that the sensing device has an unobstructed view of the wound within the open center area while not interfering with the pressure-relieving function of the cushion surfaces. This configuration can allow for continuous monitoring of a wound, particularly an open wound, situated within the pressure-free zone created by the open center. The sensing device may capture real-time visual data of the wound, enabling healthcare providers to assess wound healing progress, detect early signs of infection, or identify any changes in wound characteristics without disturbing the patient or compromising the pressure relief provided by the device. Once captured, the visual data from the sensing device is transmitted to a secure, centralized data processing system. The data processing system may be integrated within the device's controller or exist as a separate, dedicated unit. In some embodiments, the visual data is processed using advanced image analysis algorithms by the data processing system, which can detect changes in wound size, color, or other relevant characteristics. The data processing system can provide the processed information to healthcare providers through a secure interface, which is accessed remotely via encrypted channels on authorized devices such as tablets or computers. The integration of wound monitoring with pressure redistribution can provide for timely interventions and personalized treatment adjustments. Additionally, data (e.g., sensor data, controller data, device data, etc.) is collected by the data processing system and stored in a database in electronic communication with the data processing system. The collected data can be used to train machine learning models for automated and personalized device settings.

In some embodiments, the cushion surfaces are constructed using heat-sealable materials, such as thermoplastic polyurethane (TPU) or polyvinyl chloride (PVC), which allow for airtight and durable seams. These features may maintain proper inflation and deflation cycles. This heat-sealing process may provide the structural integrity of the cushion surfaces, reducing the risk of leaks and enhancing the overall longevity of the device. Additionally, the cushion surfaces may incorporate one or more specialized materials to address specific challenges in pressure ulcer care. The cushion surfaces may include an antimicrobial material, such as silver-infused fabric or copper-embedded polymers, to inhibit bacterial growth, reducing the risk of infection in vulnerable areas. In some embodiments, moisture-wicking materials, like certain polyesters or nylons with hydrophobic properties, are integrated into the cushion surfaces to draw perspiration and other fluids away from the skin, maintaining a dry environment that is less conducive to skin breakdown and maceration. Friction-reducing materials, such as low-friction coatings or specialized fabrics with a low coefficient of friction, can be incorporated into the cushion surfaces to minimize shear forces on the skin as the patient moves or is repositioned. These materials may work synergistically to create a multi-functional surface that not only provides pressure redistribution but also actively contributes to maintaining skin health and integrity.

In some embodiments, the device may include an enclosure for housing the cushion surfaces. The enclosure may protect the cushion surfaces from external damage and contamination. The enclosure may integrate the individual cushion surfaces into a cohesive unit, simplifying handling and placement. The enclosure may provide structural support to maintain the overall shape and arrangement of the cushion surfaces to assist in consistent pressure distribution. The enclosure may adapt to various underlying surfaces such as hospital beds or wheelchairs. Materials for the enclosure may include medical-grade polymers like polyurethane or silicone, antimicrobial fabrics, and breathable, moisture-wicking materials. The enclosure may include a removable and washable outer layer for easy maintenance. The enclosure may further include reinforced areas corresponding to high-stress points, and adjustable straps or fasteners for secure attachment to underlying surfaces.

The expansion console may include a power source and an inflation unit. The power source, such as a rechargeable battery, direct electrical connection, or a combination of both, may provide the necessary energy to operate the entire system. The inflation unit may include an air pump or compressor, pressure sensors, and control valves. The inflation unit is responsible for inflating and deflating the cushion surfaces. In some embodiments, the expansion console works by drawing power from the power source to drive the air pump, which generates pressurized air. The pressurized air is then directed through a network of channels (or tubes) to the individual cushion surfaces, with the flow controlled by electronically operated valves. The channels may connect the cushion surfaces to the inflation unit. Pressure sensors may continuously monitor the inflation levels of each cushion surface, feeding this data back to the control system. The expansion console may also include a user interface for manual adjustments and a microprocessor for executing pre-programmed pressure redistribution algorithms.

The channels are designed to efficiently transfer air between the inflation unit and individual cushion surfaces. In some embodiments, the channels are constructed from flexible, durable materials such as medical-grade silicone, polyurethane, or reinforced PVC, chosen for their ability to withstand repeated flexing, resist kinking, and maintain airtightness. The channels may feature a multi-layered construction, with an inner layer optimized for smooth airflow and an outer layer providing protection and durability. The channels may connect to the inflation unit via a manifold or distribution block, which allows for individual control of each channel. At the cushion surface end, the channels may attach using quick-connect fittings, threaded connectors, or heat-sealed joints, depending on the specific design requirements. These connection points may minimize air leakage while allowing for easy detachment for maintenance or replacement of individual cushion surfaces. The channels' design may include features to prevent complete blockage if compressed, such as internal ribbing or a partially flattened cross-section. Additionally, the channels may be bundled and sheathed to reduce tangling and simplify routing through the device.

The controller may serve as the central processing unit of the device, controlling the operations of various components to achieve effective pressure redistribution. In some embodiments, the controller may include a microprocessor with embedded software, interfacing with sensors, the inflation unit, and a user control panel. The controller is activated via a power button or switch, located on the device's external housing or user interface panel. Once activated, the controller may initialize a self-diagnostic routine before entering its operational mode. The controller may interact with pressure sensors in each cushion surface to monitor real-time inflation levels, and with the expansion console to regulate air flow. To create a cyclical pattern of pressure redistribution, the controller may execute pre-programmed algorithms that dictate the timing and degree of inflation for each cushion surface. These algorithms may be customizable based on patient needs, wound locations, or specific medical requirements. The controller may send signals to the expansion console's valves and pump, precisely controlling the inflation and deflation of individual cushion surfaces. The controller may use techniques such as gradient inflation (where adjacent surfaces are inflated to different degrees) or wave-like patterns (where inflation progresses across surfaces sequentially). The controller may also manage inflation speed and pressure levels to ensure patient comfort and safety. Additionally, the controller may incorporate feedback mechanisms, adjusting its operation based on data from integrated sensors that monitor factors like patient movement, moisture levels, or temperature. The controller can be programmed to alert caregivers of issues such as prolonged high pressure in specific areas, system malfunctions, or when manual patient repositioning is recommended.

The controller can dynamically adjust the inflation and deflation of the cushion surfaces based on sensor data. The controller can interface with various types of sensors, including pressure sensors (e.g., embedded in each cushion surface), moisture detectors, temperature sensors, etc. The controller can continuously receive and process this data in real-time to interpret the information and make informed decisions about necessary adjustments. For example, if the pressure sensors detect prolonged high pressure in a specific area, the controller may initiate a more rapid deflation cycle for that cushion surface while slightly inflating adjacent surfaces to redistribute the load. Similarly, if moisture sensors indicate increased humidity, the controller may adjust the inflation pattern to promote air circulation or reduce skin maceration risk. The controller can also respond to changes in the patient's position or movement, detected by accelerometers or pressure distribution changes, by altering the inflation sequence to maintain optimal support. The controller may use temperature data from temperature sensors (e.g., embedded in each cushion surface) to fine-tune inflation levels to manage heat buildup and maintain skin integrity. In some embodiments, the controller may use machine learning algorithms to recognize patterns over time, anticipating the need for adjustments based on historical data and individual patient characteristics. This sensor-driven adjustment capability may provide the system to provide personalized, dynamic pressure relief that adapts to the changing needs of the patient throughout their use of the device.

In some embodiments, the variation of inflation degrees in cushion surfaces over time to create a cyclical pattern of pressure redistribution is advantageous for several reasons. This dynamic approach may mimic the natural movement of a healthy individual, who unconsciously shifts position periodically to relieve pressure on specific body areas. By continuously altering the pressure points, the device may reduce the risk of pressure ulcer formation, which typically occurs when sustained pressure compromises blood flow to tissues. This cyclical pattern may provide that no single area of the body is subjected to prolonged pressure, thereby maintaining adequate blood circulation and tissue oxygenation. Moreover, this dynamic redistribution may stimulate minor muscle movements and enhance lymphatic drainage, further contributing to tissue health.

In some embodiments, the controller may create and dynamically adjust cyclical patterns of pressure redistribution by using sensor data. The controller may receive input from the sensors (e.g., pressure sensors in each cushion surface, as well as from moisture, temperature, and potentially motion sensors, etc.). The controller may process the sensor data to assess various states, including but not limited to the current state of pressure distribution, tissue perfusion, and overall patient condition. Based on this analysis, the controller may generate a customized inflation and deflation sequence for the cushion surfaces. For example, if the pressure sensors detect areas of consistently high pressure, the controller may increase the frequency or duration of deflation cycles for those specific areas. In some embodiments, the cyclical pattern is not a one-size-fits-all approach; rather, it is a dynamic sequence that adapts to the patient's changing needs. The controller may anticipate pressure buildup based on user historical data and adjust the cyclical patterns preemptively. The controller can also modify the intensity and speed of inflation/deflation cycles based on sensor feedback, providing that pressure relief is both effective and comfortable for the patient. In response to moisture or temperature data, the controller may alter the pattern to promote better air circulation in specific areas. Furthermore, the controller can adjust the overall rhythm of the cyclical pattern in response to detected patient movements or positional changes. These features may provide consistent pressure redistribution even as the patient shifts.

In some embodiments, the controller is operated remotely via a mobile device, such as a smartphone or tablet, which can connect wirelessly to the controller through a communication channel like Bluetooth or Wi-Fi. This wireless connectivity can provide for convenient, real-time control of the controller without the need for physical proximity to the device. The mobile device may run a specialized software application featuring a user-friendly interface that allows for comprehensive control of the pressure-reducing device including the controller. Through the software application, users can initiate and manage the inflation and deflation of cushion surfaces, adjust the degrees of inflation, and modify the cyclical patterns of pressure redistribution. The software application may also offer preset programs for different scenarios, allow for the creation of custom inflation patterns, and provide real-time feedback on the device's operation.

Furthermore, the software application on the mobile device may receive and/or display data from all sensors integrated into the pressure-reducing device. This may include data from pressure distribution sensors, tissue oxygenation sensors, moisture sensors, temperature sensors, and any other sensors present in the system. The software application can process and present the received data in an easily interpretable format, allowing healthcare providers or caregivers to monitor the user's condition in real-time. These features may provide for quick identification of potential issues, facilitate data-driven decision making, and allow for immediate adjustments to the device's settings based on the sensor readings, all from the convenience of a mobile device. The wireless nature of this connection ensures that monitoring and control is performed from a distance, promoting efficient patient care and reducing the need for constant bedside presence.

In some embodiments, the device may include two cushion surfaces, which are inflated in a rotating order to create a gentle rocking motion that shifts the user body weight between them. As one cushion surface inflates, the other deflates, transferring the body's weight to the inflating surface while simultaneously offloading pressure from the deflating surface. This alternating pattern may provide that each body area in contact with the cushion surfaces experiences regular periods of reduced pressure, allowing for reperfusion of tissues and prevention of ischemia. The simplicity of this two-surface design may make it particularly suitable for specific applications, such as wheelchair cushions or smaller support surfaces, where a more complex multi-surface system may be impractical. Additionally, this embodiment is easily adjusted for different cycle times and inflation levels, allowing for customization based on individual patient needs, such as their risk level for pressure ulcers or specific anatomical considerations. The continuous, gentle movement provided by this embodiment may not only prevent pressure ulcers but can also enhance patient comfort and potentially reduce the frequency of manual repositioning required by caregivers.

In some embodiments, the controller can receive sensor data, compare the received sensor data to preset thresholds, and responsive to comparing the received sensor data to preset thresholds, provide an alert to the user. The alert may indicate a likelihood of pressure ulcer formation, a likelihood of device damage, and a likelihood of device failure. The controller's alert system may function as a safeguard, continuously monitoring and analyzing data from multiple sensors to preemptively identify potential issues. The controller may receive real-time input from various sensors, including pressure sensors, moisture detectors, temperature monitors, and device performance indicators. This data may then be compared against preset thresholds, which are calibrated based on, for example, clinical guidelines, device specifications, and customized for individual patient needs. When sensor readings exceed these predetermined thresholds, the controller may trigger specific alerts. For example, if pressure sensors detect prolonged high pressure in a particular area beyond the set limit, the controller may alert users to a heightened risk of pressure ulcer formation, prompting immediate intervention. Similarly, if moisture levels exceed the threshold, an alert may indicate an increased risk of skin maceration. The alerts can be visual (e.g., on-screen notifications or LED indicators), audible alarms, or even notifications sent to connected devices or central nursing stations. The thresholds for these alerts can often be adjusted by users or healthcare providers to accommodate varying patient conditions or institutional protocols.

Various sensors may be mounted on individual cushion surfaces to provide comprehensive monitoring of patient condition and device performance. In some embodiments, pressure distribution sensors are embedded throughout the surface of each cushion, using capacitive or resistive sensing to detect localized pressure levels, enabling the system to identify potential pressure points. Tissue oxygenation and pulse oximetry sensors can be placed at the edges of cushion surfaces that contact areas prone to pressure ulcers, such as the sacrum or heels, using near-infrared spectroscopy to measure tissue oxygen levels and blood flow. Doppler ultrasound sensors may be mounted at anatomical points to detect deep tissue blood flow, providing early warning of potential deep tissue injury. Moisture and humidity sensors may be distributed across the cushion surface (for e.g., integrated with the cover material) to detect perspiration or incontinence that could compromise skin integrity. Temperature sensors may be placed at regular intervals across the cushion surface to monitor for any concerning changes in skin temperature that might indicate inflammation or reduced circulation. Tissue color sensors, utilizing spectral imaging technology, may be positioned adjacent to a cushion surface to observe areas at high risk for pressure ulcers, detecting early signs of tissue discoloration. Electrocardiogram sensors may be placed on cushion surfaces that contact the upper back or chest area, providing heart rate and rhythm monitoring. Motion sensors, such as accelerometers, may be integrated into the cushion structure to detect patient movement and positional changes, informing the system about the effectiveness of pressure redistribution. Each of these sensors may work in concert with the controller, providing real-time data that enables the device to dynamically adjust its pressure redistribution patterns, alert caregivers to potential issues, and maintain an optimal environment for pressure ulcer prevention and overall patient health monitoring.

The device may further include a treatment dispenser for providing a treatment to the user alongside pressure redistribution. For example, the treatment dispenser is mounted on at least one of the cushion surfaces. It may also be mounted into the center of the device between the cushions, or directly underlying an existing wound or treatment region of interest. The treatment dispenser may include a light therapy device that provides light therapy to a region of the body of the user. The treatment dispenser may include a layer of material coated with a medication, an ointment, or a therapeutic solution. Mounted directly on one or more cushion surfaces, the treatment dispenser may integrate seamlessly into the device's structure, allowing for targeted treatment delivery to specific body regions. In the light therapy embodiment, the dispenser may include a plurality of LED lights embedded within or attached to the cushion surface. These lights can emit specific wavelengths (e.g., red or near-infrared) known to promote wound healing, increase circulation, and reduce inflammation. The light therapy can be programmed to activate during pressure-off cycles, ensuring optimal light penetration to the target tissues. In the medication/ointment delivery embodiment, the treatment dispenser may include a layer of material, such as a porous membrane or a micro-needle array, coated or impregnated with therapeutic agents. This layer may be designed to make direct contact with the user's skin or wound area. The medication or ointment can be gradually released through body heat, moisture, or mechanical action as the user moves. The release may be controlled electronically, coordinating with the pressure redistribution cycles. Both embodiments of the treatment dispenser may work in synergy with the pressure-relief function of the device. For example, during periods of reduced pressure on a specific area, the light therapy can be activated or the medicated layer can make optimal contact with the skin. The controller can manage the treatment dispensers, adjusting therapy based on sensor data such as tissue oxygenation levels or moisture readings. This integration of treatment dispensing with pressure relief can create a multifunctional therapeutic surface, enhancing wound healing, pain management, and overall efficacy in pressure ulcer prevention and treatment.

The pressure-relief device may include versatile fastening mechanisms to securely attach the cushion surfaces to various external surfaces, ensuring stability and optimal performance across different use scenarios. For example, the fastener can include a seatbelt mechanism, glue, buttons, magnets, a suction cup, or a hook-and-loop fastener (e.g., Velcro straps). The fastener can include an elastic material for positioning the cushion surfaces on the external surface. The seatbelt mechanism can include adjustable straps with buckles or clasps, allowing for quick and secure attachment to surfaces like hospital beds or wheelchairs, providing a robust hold while allowing for easy removal when necessary. Adhesive-based fasteners, such as glue or strong, removable adhesives, may provide a more permanent solution for surfaces where drilling or other modifications are undesirable. Suction cups may provide a non-permanent, easily adjustable option ideal for smooth, non-porous surfaces, allowing for quick repositioning of the device. Hook-and-loop fasteners (e.g., Velcro straps) may provide a balance of security and ease of removal, making them suitable for frequent adjustments or when the device needs to be regularly transferred between different surfaces.

The elastic material option, which may take the form of a fitted sheet-like cover or stretchable straps, may allow the device to conform snugly to various surface shapes and sizes, providing a secure fit while accommodating different contours. This elastic solution is particularly useful for irregularly shaped surfaces or when frequent repositioning is required. Each of these fastening options can contribute to the device's adaptability, allowing it to be securely used on a wide range of surfaces from hospital beds and operating tables to home furniture and mobility aids. The choice of fastener is tailored to the specific use case, considering factors such as the frequency of repositioning, the nature of the underlying surface, and the need for rapid deployment or removal.

A method for reducing pressure against a region of a body of a user can include: positioning a plurality of inflatable cushion surfaces against the region of the body of the user, and inflating or deflating each individual cushion surface to vary a degree of inflation of each individual cushion surface over time and create a cyclical pattern of pressure redistribution such that pressure exerted on any specific point of the region of the user's body is periodically relieved. The cyclical pattern may include alternating periods of first range of pressure and a second range of pressure for each individual cushion surface. The periods of the first and second ranges of pressure for adjacent cushion surfaces can be offset in time to maintain overall support of the user body while providing localized pressure relief. A duration and intensity of inflation and deflation cycles may be adjustable based on user-specific parameters including at least one of body weight, wound status data, and a likelihood of pressure ulcer formation.

In some embodiments, the method for reducing pressure against a body region may use a practical approach to dynamic pressure redistribution. It may begin with the strategic positioning of multiple inflatable cushion surfaces against the target body area, creating a supportive foundation. The core of the method may lie in its cyclical inflation and deflation pattern, where each cushion surface undergoes controlled changes in inflation levels over time. This feature may create a dynamic support system where the pressure exerted on any specific point of the body is periodically relieved, mimicking the natural movement patterns that prevent pressure ulcer formation. In some embodiments, the cyclical pattern may alternate between two pressure ranges for each cushion surface: a first range providing full support and a second range offering pressure relief. The timing of these alternating periods may be offset between adjacent cushion surfaces, ensuring that while one area experiences pressure relief, the surrounding areas maintain support, thus preventing overall instability or discomfort for the user. This coordinated offset timing helps to provide localized pressure relief without compromising the overall support structure. The method's adaptability is further enhanced by its ability to adjust the duration and intensity of inflation cycles based on user-specific parameters. Factors such as body weight may influence the pressure levels needed for effective support and relief; wound status data may help tailor the cycle to avoid exacerbating existing injuries; and the likelihood of pressure ulcer formation may guide the overall aggressiveness of the pressure relief strategy. These features may allow the device to provide optimal pressure redistribution for each individual user, maximizing the effectiveness of pressure ulcer prevention while providing comfort and stability.

The subject matter described herein has broad applicability across various medical fields. For example, venous ulcers, diabetic foot ulcers, and other chronic wounds may benefit from the same therapeutic approach. These conditions may involve prolonged pressure or compromised blood flow, leading to tissue breakdown and slow healing. The device's ability to alleviate pressure, improve circulation, and support tissue regeneration can significantly enhance treatment outcomes in such cases. Additionally, the subject matter can be applied to conditions like varicose veins and lymphedema, where pressure management and improved vascular health may be vital for mitigating symptoms and preventing further tissue damage.

The subject matter described herein may be used to prevent and/or treat conditions such as deep vein thrombosis (DVT), where pressure management and improved circulation are crucial in preventing blood clots from forming in deep veins. Similarly, burns and skin grafts, where tissue healing and protection from further damage are paramount, could also benefit from the subject matter provided herein to enhance tissue repair. Furthermore, certain orthopedic conditions, such as joint pressure injuries or post-surgical recovery areas, may benefit from the subject matter provided herein for promoting proper healing and preventing complications related to pressure-induced damage.

### Example Embodiments

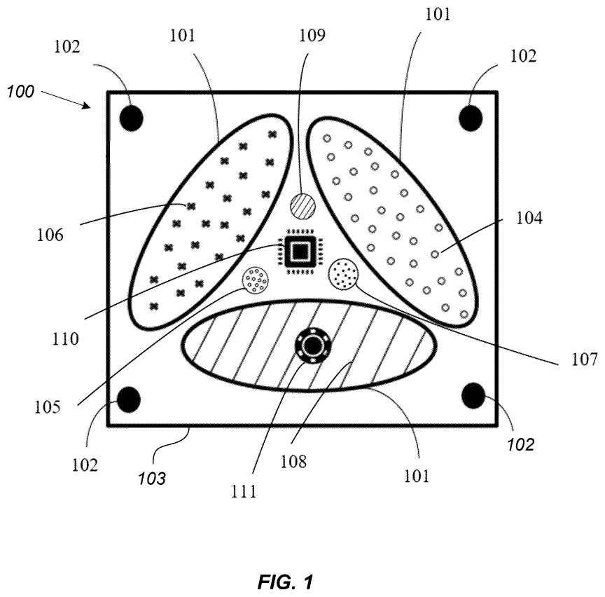

FIG. 1 illustrates a device 100 designed for reducing pressure against a region of a user's body, incorporating multiple therapeutic and monitoring features. The device 100 includes inflatable cushion surfaces 101, an expansion console (not shown) and a controller (not shown). The expansion console may include a power source and an inflation unit. A plurality of channels may connect the cushion surfaces 101 to the inflation unit. The inflatable cushion surfaces 101 can be used independently or held together by an optional casing 103 (e.g., a flat support). The device 100 is secured to external surfaces like beds or chairs using fasteners 102, which may include buttons, Velcro, or magnets.

The device 100 includes various treatment dispensers. The treatment dispensers include a light therapy device 104 mounted directly on a cushion surface for localized treatment. The light therapy device 104 may provide light therapy to a region of the body of the user. The treatment dispensers may also include layers of materials 106, 108 mounted on cushion surfaces and coated with a medication, an ointment, or a therapeutic solution. The treatment dispensers may further include drug delivery mechanisms 105 (e.g., light therapy), 107 (e.g., porous cells for drug delivery), 109 (e.g., coating with a medication, an ointment, or a therapeutic solution) mounted anywhere on the casing 103. The drug delivery mechanisms 105, 107, and 109 can be fixed to the casing 103 or moveable to target specific body regions. The treatment options may range from cool air or medicated gas delivery through porous cushion surfaces with antibacterial or anti-inflammatory properties. Some cushion surfaces 101 may also provide a massaging effect through controlled inflation and deflation. This massage effect provides comfort to users by stimulating blood flood, etc. The device 101 may include multiple sensors 110, 111 positioned on the cushion surfaces 101, the casing 103, or externally, for monitoring of vital signs, temperature, movement, and even sleep cycles. The sensors may allow for real-time data collection. The sensor data can be collected by the controller and stored on a database thereon. The controller may send the collected data to external systems and databases. For example, a software application on a mobile device may wirelessly (e.g., via Bluetooth, Wi-Fi, etc.) connect to the controller to receive, store, or display data collected therefrom.

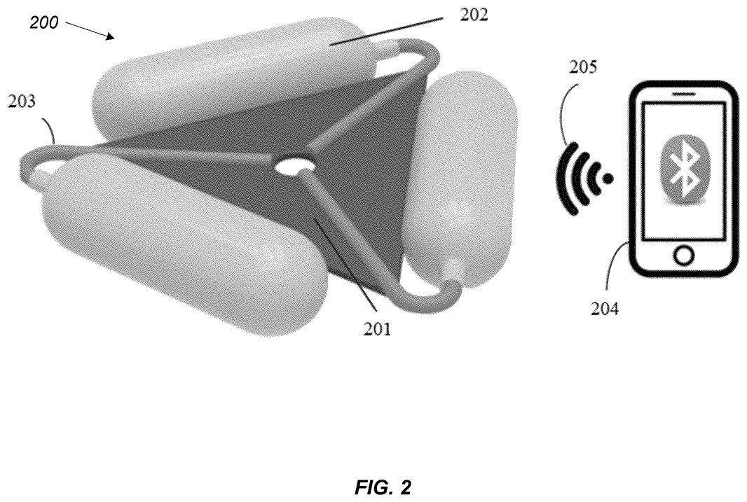

FIG. 2 illustrates an exemplary device 200 for reducing pressure against a region of a user's body. The device 200 includes a casing 201, inflatable cushion surfaces 202, channels 203, an expansion console (not shown), and a controller (not shown). The casing 201 houses and protects the internal components of the device 200. Inside the casing 201 are multiple inflatable cushion surfaces 202, which form the core of the pressure redistribution mechanism. The expansion console may include a power source and an inflation unit. The cushion surfaces 202 are connected to the inflation unit (not shown) via a network of channels 203, allowing for precise control of air flow to each individual cushion 202. The casing 201 may house the controller. A mobile device 204 (e.g., a computing device) may connect to the controller to manage the operations of the device 200. The controller is programmed to direct the expansion console in inflating and deflating the cushion surfaces 202, creating a dynamic, cyclical pattern of pressure redistribution. Communication between the controller and the mobile device 204 is facilitated by a wire connection or a wireless network 205 such as Wi-Fi or Bluetooth.

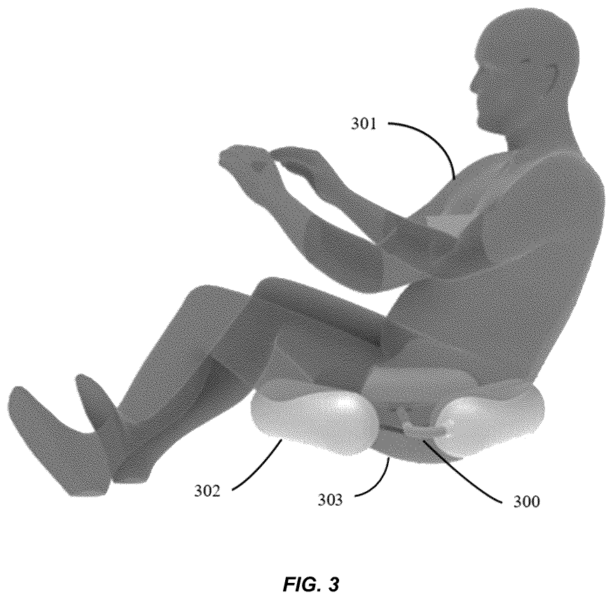

FIG. 3 illustrates a device 300 for reducing pressure against a region of a user's body in action. FIG. 3 shows a user 301 positioned on the device, with the inflatable cushion surfaces 302 actively supporting and interacting with the user's body. Of particular note is the body region 303, which is visibly elevated and free from pressure, showcasing the device's ability to target and treat specific areas of the user's body.

The cushion surfaces 302 are arranged to form a customized support structure that adapts to the user's unique body contours. The cushion surfaces 302 can operate in a cyclical pattern of inflation and deflation, creating a dynamic pressure redistribution system. As one set of cushions inflates to provide support, adjacent cushions are deflated to relieve pressure, providing that no single point on the body experiences prolonged pressure. This cyclical pattern mimics natural movement, promoting blood flow and preventing the formation of pressure ulcers. The device's design allows for customization to accommodate a wide range of body regions, sizes, and weights. The number, size, and arrangement of the cushion surfaces can be adjusted to suit specific needs, whether it is targeting a small area like a heel or supporting the entire torso. The inflation levels and cycle timings can be fine-tuned based on factors such as the user's weight, the presence of existing wounds, or the risk of pressure ulcer formation. The device can be adapted for use with non-human subjects, particularly large animals that are undergoing surgery or immobilized for extended periods.

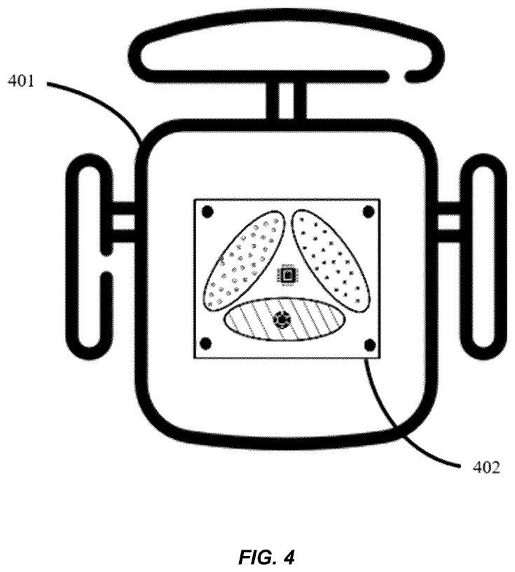

FIG. 4 illustrates a pressure-reducing device 402 mounted on a seating surface 401, which could represent a chair, wheelchair, automobile seat, or similar sitting platform. This configuration shows the device's adaptability beyond traditional bed-based pressure relief systems, addressing the critical need for pressure management in seated positions. The device 402 is mounted on the seating surface 401, conforming to its shape while providing a layer of dynamic support between the user and the seat. The inflatable cushion surfaces of the device are arranged to target key pressure points typically experienced during prolonged sitting, such as the ischial tuberosities, sacrum, and thighs. In the seated configuration, the device may use a modified cyclical inflation pattern optimized for the biomechanics of sitting. The inflation and deflation cycles are designed to subtly shift the user's weight distribution without compromising overall stability or posture.

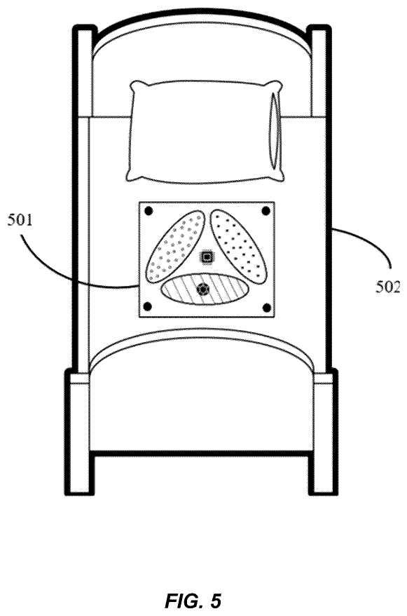

FIG. 5 illustrates a pressure-reducing device 501 mounted on a bed surface 502, showcasing its application in a setting where users may spend extended periods in a recumbent position. This configuration demonstrates the device's adaptability to larger surfaces and its potential for continuous, long-term use in both medical and home care environments.

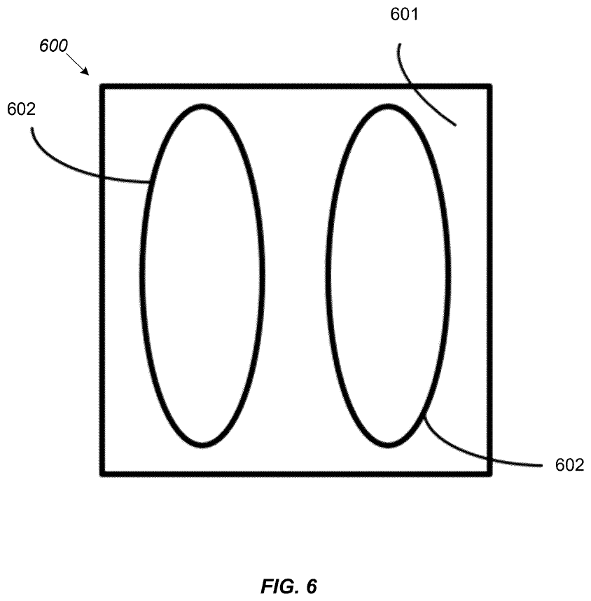

FIG. 6 depicts a pressure-reducing device 600, featuring two inflatable cushion surfaces 602 enclosed within a protective casing 601. The two cushion surfaces 602 are arranged side by side or in a configuration that allows for alternating pressure relief. As one cushion inflates, the other can deflate, creating a rocking or alternating pressure pattern that periodically shifts the user's weight. This dynamic action helps prevent prolonged pressure on any single area of the body, crucial for reducing the risk of pressure ulcers. The casing 601 serves to contain and protect the cushion surfaces, providing structure to the device and potentially housing control mechanisms or connection points for inflation systems.

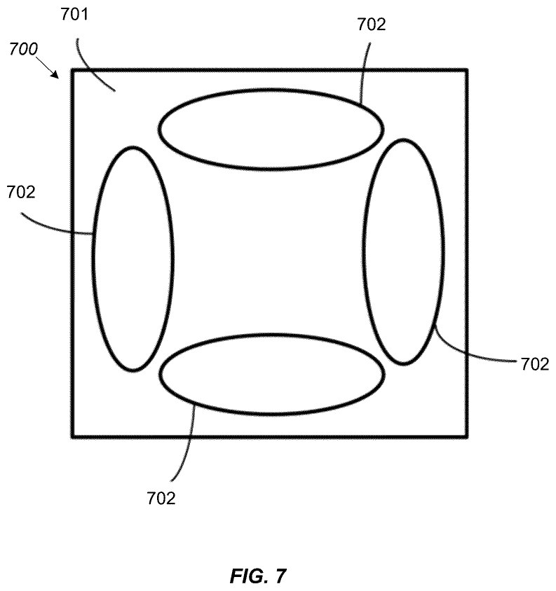

FIG. 7 illustrates a pressure-reducing device 700, having four inflatable cushion surfaces 702 contained within a protective casing 701. The four cushions are arranged in a grid or strategic pattern to provide comprehensive coverage and support for larger body areas. The device can alternate inflation among the four cushions in various sequences, offering greater flexibility in managing pressure points and accommodating different body positions or specific medical needs.

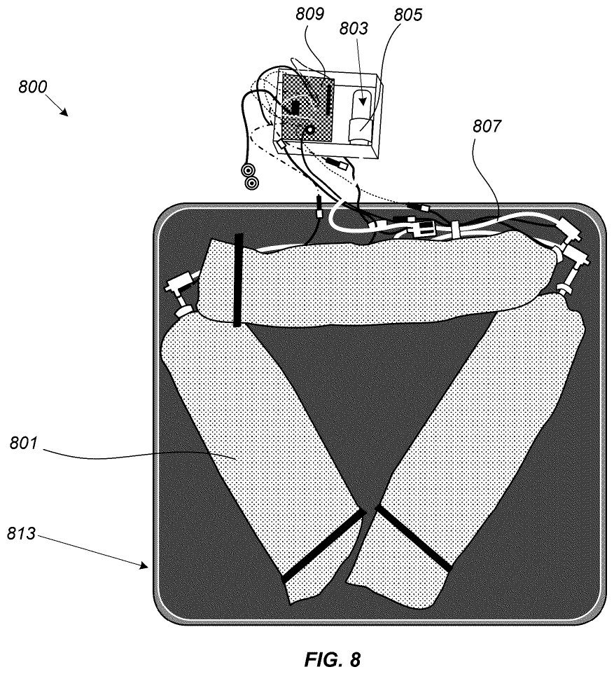

FIG. 8 shows a device 800 designed for reducing pressure against a region of a user's body. The device 800 includes a plurality of inflatable cushion surfaces 801 for supporting the body region of the user. The device 800 includes an expansion console 803 having a power source (not shown) and an inflation unit 805. The device 800 further includes a plurality of channels 807 connecting the cushion surfaces 801 to the inflation unit 805. The device 800 has a controller 809 configured to cause the expansion console to inflate or deflate any one of the cushion surfaces 801 (e.g., individually) so as to vary degrees of inflation of the cushion surfaces 801 over time to create a cyclical pattern of pressure redistribution. In some embodiments, the controller 809 may inflate the cushion surface 801 at the head end of the device while simultaneously deflating the cushion surfaces 801 at the foot end, creating a gentle tilting motion that shifts pressure from the user's upper body to their lower body and vice versa over time. In some embodiments, in a rotating pattern, the controller 809 may fully inflate one cushion surface 801 while partially deflating the adjacent surfaces, then move this pattern across all surfaces sequentially, creating a wave-like effect that continuously redistributes pressure across the user's body. In some embodiments, for targeted pressure relief, the controller 809 may maintain inflation in most cushion surfaces 801 while completely deflating one or two surfaces beneath a high-risk area (like the sacrum or heels), then rotate this relief to different areas on a timed cycle. These examples illustrate just a few of the many possible inflation and deflation patterns that the controller 809 can implement. The controller 809 is not limited to these specific scenarios and is programmed to execute a wide variety of cyclical patterns tailored to individual user needs, specific medical conditions, or particular body areas requiring attention. The flexibility of the control design allows for countless combinations of inflation and deflation sequences across the cushion surfaces 801, allowing highly customized and dynamic pressure redistribution strategies.

The casing is a pressure sensor mat 813 where the inflatable cushion surfaces 801 are mounted. The pressure sensor mat 813 can capture real-time pressure measurements across the surface areas, allowing for monitoring of pressure distribution between the user's body and the device 800. The pressure sensor mat 813 is in communication with the controller 809 for continuous data collection and providing the controller 809 with real-time information about the pressure distribution across the cushion surfaces 801. Communication between the pressure sensor mat 813 and the controller 809 may create a feedback loop, allowing the controller 809 to make informed decisions about how to adjust the inflation and deflation of individual cushion surfaces 801. Using the pressure data, the controller 809 may create more personalized and responsive cyclical patterns of pressure redistribution, identifying areas of high pressure and adjusting the inflation of specific cushion surfaces 801 accordingly. In some embodiments, the pressure sensor mat 813 may help detect any abnormal pressure points or distributions, potentially alerting the user or caregiver to reposition the user or adjust the device settings. Over time, the data collected from the pressure sensor mat 813 is used to assess the efficacy of the device in redistributing pressure and preventing pressure injuries.

In some embodiments, a device for reducing pressure against one or more region of a patient's body is integrated into an artificial intelligence platform (or system). The platform includes, among other elements, a surface for receiving a patient's body (e.g., a hospital bed, etc.) and a plurality of sensors such as pressure sensors and position sensors. The surface is not limited to inflatable regions but can incorporate any mechanism capable of raising or lowering different regions of the surface to adjust pressure distribution. For example, the surface may utilize a plurality of small, independently controlled mechanical lifts that can elevate or lower specific sections of the surface, allowing for dynamic pressure redistribution without the need for inflation or deflation.

In some embodiments, the pressure sensors are integrated into a flexible pressure mat that covers the entire surface, allowing for measurement of pressure distribution across multiple regions of the patient's body. The pressure sensors can measure and map the pressure distribution across the patient's body with high precision. The platform includes position sensors to track and analyze the patient's posture and movements in real-time. The position sensors can include, among others, sensing devices, infrared cameras, depth sensors, and accelerometers. The position sensors can be strategically placed around the contact surface to provide comprehensive coverage. The position sensors can create a detailed three-dimensional model of the patient's body position for detecting shifts in posture or limb placement.

The platform includes a database to collect and store data from the different sensors over time. The platform includes one or more processors for running applications (e.g., machine learning algorithms) on the collected data. The platform can also include a graphical user interface that displays the pressure points of the patient on the surface and visualizes how these pressure points evolve over time using for e.g., color-coded heat maps and/or trend graphs. The interface can provide healthcare professionals with real-time, easy-to-interpret data on the patient's body pressure distribution.

The platform includes a first machine learning model designed to correlate pressure data with body position data over time and assign each pressure reading to a specific body part. For example, this model processes inputs from the contact surface and position sensors, using techniques such as convolutional neural networks for image recognition and spatial mapping to identify the location and orientation of the patient's body. The model then associates each pressure data point with the corresponding body part for creating a map that links pressure readings (e.g., 45 mmHg) with specific anatomical locations (e.g., left shoulder blade). This mapping provides tracking of pressure distribution across different body parts, allowing for targeted intervention. The output of the first machine learning model, which includes the mapped associations between pressure readings and specific body parts, can be stored in a database for historical tracking and further analysis. The output of the first machine learning model can also be displayed on the graphical user interface.

The platform includes a second machine learning model that processes the pressure data associated with specific body regions as output by the first model and stored in the database, along with historical pressure trends and patient-specific risk factors. The second machine learning model can generate two types of outputs: (1) precise instruction signals to be sent directly to the controller for automatic surface adjustments (e.g., signals to raise section C of the surface by 2 cm to relieve pressure on the sacrum, or to create a gentle undulating motion to promote blood flow); and (2) warnings or recommendations displayed on the graphical user interface (e.g., suggest repositioning patient to left side-lying position within the next 30 minutes to alleviate prolonged pressure on right hip, or recommend a specific pressure-relieving cushion for high-risk areas). These features of the platform can provide automated pressure management and informed human intervention, optimizing patient care and pressure ulcer prevention.

### Computing Machine Architecture

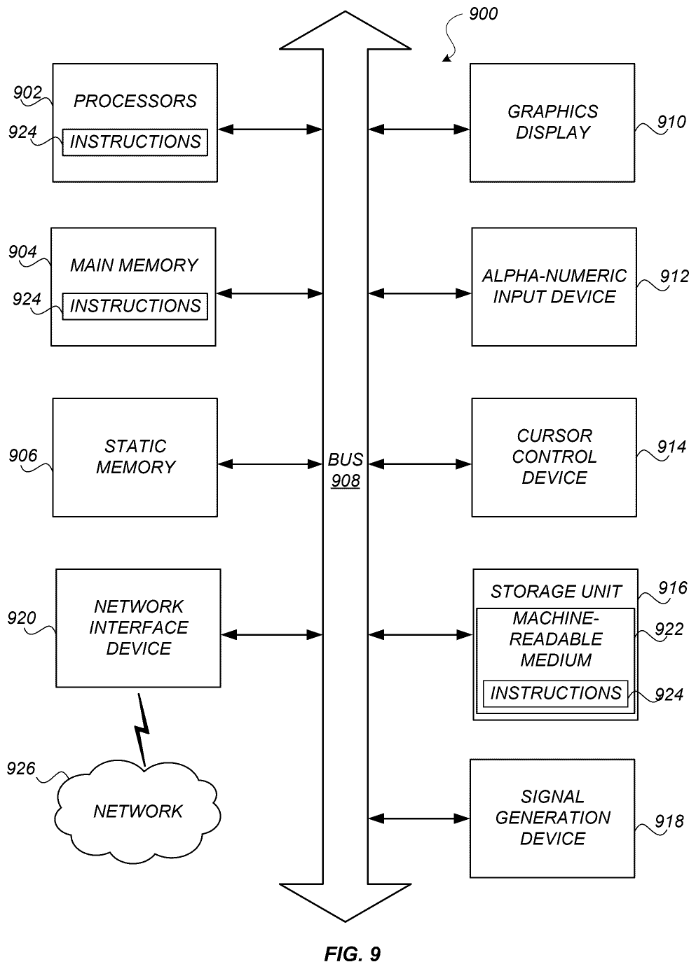

FIG. 9 is a block diagram illustrating components of an example computing machine (e.g., a controller) that is capable of reading instructions from a computer-readable medium and executing them in a processor. A computer described herein may include a single computing machine shown in FIG. 9, a virtual machine, a distributed computing system that includes multiple nodes of computing machines shown in FIG. 9, or any other suitable arrangement of computing devices.

By way of example, FIG. 9 shows a diagrammatic representation of a computing machine in the example form of a computer system 900 within which instructions 924 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 9 may correspond to any software, hardware, or combined components of the controller shown in 2, including but not limited to, the controller 204 (or client device).

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 924 that specify actions to be taken by that machine. Further, while only a single machine is illustrated, the terms “machine” and “computer” may also be taken to include any collection of machines that individually or jointly execute instructions 924 to perform any one or more of the methodologies discussed herein.

The example computer system 900 includes one or more processors 902 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 900 may also include a memory 904 that stores computer code including instructions 924 that may cause the processors 902 to perform certain actions when the instructions are executed, directly or indirectly by the processors 902. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 902 and reduce the space required for the memory 904. For example, the database processing techniques and machine learning methods described herein reduce the complexity of the computation of the processors 902 by applying one or more novel techniques that simplify the steps in training, reaching convergence, and generating results of the processors 902. The algorithms described herein also reduce the size of the models and datasets to reduce the storage space requirement for memory 904.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes to be performed by a processor, this may be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 900 may include a main memory 904, and a static memory 906, which are configured to communicate with each other via a bus 908. The computer system 900 may further include a graphics display unit 910 (e.g., a plasma display panel (PDP), a liquid crystal display (LCD), a projector, or a cathode ray tube (CRT)). The graphics display unit 910, controlled by the processor 902, displays a graphical user interface (GUI) to display one or more results and data generated by the processes described herein. The computer system 900 may also include an alphanumeric input device 912 (e.g., a keyboard), a cursor control device 914 (e.g., a mouse, a trackball, a joystick, a motion sensor, or other pointing instruments), a storage unit 916 (a hard drive, a solid-state drive, a hybrid drive, a memory disk, etc.), a signal generation device 918 (e.g., a speaker), and a network interface device 920, which also are configured to communicate via the bus 908.

The storage unit 916 includes a computer-readable medium 922 on which is stored instructions 924 embodying any one or more of the methodologies or functions described herein. The instructions 924 may also reside, completely or at least partially, within the main memory 904 or within the processor 902 (e.g., within a processor's cache memory) during execution thereof by the computer system 900, the main memory 904 and the processor 902 also constituting computer-readable media. The instructions 924 may be transmitted or received over a network 926 via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store instructions (e.g., instructions 924). The computer-readable medium may include any medium that is capable of storing instructions (e.g., instructions 924) for execution by the processors (e.g., processors 902) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g., computer program product, system, or storage medium, as well. The dependencies or references in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A device for reducing pressure against a region of a body of a user, the device comprising:
a plurality of inflatable cushion surfaces for supporting the body region of the user;
an expansion console comprising a power source and an inflation unit;
a plurality of channels connecting the cushion surfaces to the inflation unit; and
a controller configured to cause the expansion console to inflate and/or deflate any one of cushion surfaces so as to vary degrees of inflation of the cushion surfaces over time to create a cyclical pattern of pressure redistribution.

2. The device of claim 1, wherein the cushion surfaces are arrangeable to form a shape with an open center area configured to elevate the region of the body of the user off an underlying surface.

3. The device of claim 1, further comprising at least one sensor mounted on an individual cushion surface.

4. The device of claim 3, wherein the at least one sensor comprises any one of:
a pressure distribution sensor;
a tissue oxygenation sensor;
a pulse oximetry sensor;
a doppler ultrasound sensor;
a moisture sensor;
a humidity sensor;
a temperature sensor;
a tissue color sensor;
an electrocardiogram sensor; and
a motion sensor.

5. The device of claim 4, wherein the controller is configured to adjust the inflation and deflation of the cushion surfaces based on sensor data.

6. The device of claim 4, wherein the controller is configured to create the cyclical pattern of pressure redistribution based on sensor data.

7. The device of claim 5, wherein the controller is further configured to:
receive data from a plurality of sensors;
compare the received data to preset thresholds; and
responsive to comparing the received data to preset thresholds, provide an alert to the user.

8. The device of claim 7, wherein the alert indicates any one of: a likelihood of pressure ulcer formation, a likelihood of device damage, and a likelihood of device failure.

9. The device of claim 1, further comprising a treatment dispenser for providing a treatment to the user.

10. The device of claim 9, wherein the treatment dispenser is mounted on at least one of the cushion surfaces.

11. The device of claim 9, wherein the treatment dispenser comprises a light therapy device configured to provide light therapy to the region of the body of the user.

12. The device of claim 9, wherein the treatment dispenser comprises a layer of material coated with a medication, an ointment, or a therapeutic solution.

13. The device of claim 1, wherein the cushion surfaces are constructed using a heat-sealable material.

14. The device of claim 1, wherein the cushion surfaces comprise any one of: an antimicrobial material; a moisture-wicking material; and a friction-reducing material.

15. The device of claim 1, further comprising a fastener for securing the cushion surfaces to an external surface.

16. The device of claim 15, wherein the fastener comprises any one of a seatbelt mechanism, glue, a suction cup, and a hook-and-loop fastener.

17. The device of claim 15, wherein the fastener comprises an elastic material for positioning the cushion surfaces on the external surface.

18. A method for reducing pressure against a region of a body of a user, the method comprising:
positioning a plurality of inflatable cushion surfaces against the region of the body of the user; and
inflating or deflating each individual cushion surface to vary a degree of inflation of each individual cushion surface over time and create a cyclical pattern of pressure redistribution such that pressure exerted on any specific point of the region of the body of the body of the user is periodically relieved.

19. The method of claim 18, wherein the cyclical pattern comprises alternating periods of first range of pressure and a second range of pressure for each individual cushion surface, and wherein the periods of the first and second ranges of pressure for adjacent cushion surfaces are offset in time to maintain overall support of the user body while providing localized pressure relief.

20. The method of claim 19, wherein a duration and intensity of inflation and deflation cycles are adjustable based on user-specific parameters including at least one of body weight, wound status data, and a likelihood of pressure ulcer formation.
